(19) United States
(12) Patent Application Publication
(10) Pub. No.: US 2007/0207778 A1
(43) Pub. Date: Sep. 6, 2007

(54) Messaging System And A Telephone Incorporating Such A System

(75) Inventors: Yannick Mahieux, Begard (FR); David Deleam, Perros-Guirec (FR); Claude Lamblin, Perros Guirec (FR)

Correspondence Address: OLIFF & BERRIDGE, PLC, P.O. BOX 19928, ALEXANDRIA, VA, 22320, US

(73) Assignee: France Telecom, Paris (FR)

(21) Appl. No.: 11/578,168

(22) PCT Filed: Apr. 20, 2004
(86) PCT No.: PCT/FR04/00971

§ 371 Date: Jan. 9, 2007

(51) Int. Cl. H04M 11/10

(52) U.S. Cl. 455/412.1

(57) ABSTRACT

The messaging system (10) comprises means (14) for storing digital audio and/or video messages and/or data. It further comprises means for truncating (26f, 44) messages coded by hierarchical encoders in order to record messages in said storage means and/or to forward messages previously recorded in said storage means.

The present invention relates to messaging systems including means for storing digital audio and/or video and/or data messages. It also relates to telephones incorporating such a system.

Digital messaging systems centralized on a server or situated in a communications terminal such as a telephone or a videoconference terminal are known in the art. It is important to be able to reproduce a message stored by the messaging system with good quality. For example, understanding a voice message and recognizing the person who left the message are greatly dependent on the quality of reproduction of the message. The quality of reproduction of a message obviously depends on the quality of the message that was left, but also on the quality of the stored message and finally on the quality of the message sent to a reader terminal.

It is also important for the messaging system to be able to store as many messages as possible, given its storage capacities.

One problem that must be solved in such messaging systems is that of managing the heterogeneous nature of the remote terminals from which the messaging systems can be contacted (remote deposition and consultation). Not all terminals have the same data receiving capacities, especially telephone terminals connected to the switched telephone network and GSM-type mobile terminals which are not equipped with broadband playback systems or coders/decoders (codecs), for example.

A known solution to this problem of managing the heterogeneous nature of the message reader terminals is to provide a messaging system including transcoding means for processing messages to be sent if the reader terminal does not have the same capacities as the terminal that deposited the message, in particular the same capacities in terms of the coding formats and bit rates supported.

It is also possible to store a recorded message in a plurality of formats each compatible with at least one format accepted by reader terminals liable to seek to download the message. This gives rise to a memory problem as it is then necessary to store a plurality of messages instead of the one message initially recorded.

Another problem that must be solved in these messaging systems is that of managing the capacity of the storage means (in the case of recording messages). According to the type of messaging system, these storage means may be allocated globally (all the users of a messaging server share all the capacity of the storage means) or in a differentiated way (for example, each user or user group has their own maximum storage capacity).

In all cases, that storage capacity is not unlimited. A simple solution to this storage capacity problem that is widely used consists in systematically prohibiting the depositing of a new message if the memory capacity of the storage means remaining available is not sufficient to accept new messages.

Transcoding to a lower bit rate coding format is another solution to increasing the number of messages stored in the messaging storage means. If congestion of the storage capacity is detected, then messages already stored are transcoded into a lower bit rate-coding format.

These transcoding operations impose an additional cost in terms of the complexity of the messaging system platform and also significantly degrade message quality.

A final solution to the two problems cited above consists in storing the messages only in a minimum bit rate format. This solution implies leveling down the quality of stored and read messages. Also, it does not avoid the transcoding operations necessary in the event of incompatible coding formats. Furthermore, in this case the number of messages stored is maximized (to the detriment of quality) without taking account of the available storage space, i.e. without optimizing management of the storage means.

The invention aims to solve the problems raised by the various prior art solutions that have been envisaged by providing a messaging system capable firstly of adapting to the heterogeneous nature of the terminals for reading stored messages and secondly of managing its storage capacity as a function of the messages received with greater flexibility and without adding to the complexity either of the computation means implemented in the messaging system or of the storage means and without leveling down the quality of stored and sent messages.

Thus the invention consists in a messaging system including storage means for storing digital audio and/or video messages and/or data, characterized in that it includes truncation means for truncating messages coded by hierarchical coders for recording messages in the storage means and/or for forwarding messages already recorded in the storage means.

Thus, by enabling the messaging system to exploit the hierarchical character of the coded messages, i.e. by providing a messaging system with means for truncating hierarchically coded messages, the problem of managing the heterogeneous nature of the reader terminals and the problem of the limited capacities of the storage means are solved simply and with no additional cost in respect of the storage means.

The capacities of a terminal for reading or depositing message are generally supplied and known when the terminal enters into communication with the messaging system.

A messaging system of the invention may further include one or more of the following features:
it includes sending means for forwarding to a remote reader terminal a message already recorded in the storage means coded by a hierarchical coder and means for determining a hierarchy level at which the message to be sent must be forwarded to the remote reader terminal so that the message is truncated by the truncation means at the hierarchy level that has been determined;
the means for determining the hierarchy level of the message to be sent are operative as a function of parameters relating to the status of the remote terminal and/or the status of the transmission network;
the remote terminal being adapted to read only messages to a predetermined format that is not compatible with the format of the message to be sent, the system further includes processor means for processing the message to be sent to render it compatible with that predetermined format;
the truncation means are adapted to truncate messages coded by hierarchical coders and already stored as a function of the filled proportion of the storage means;
the system includes recording means for recording a new digital message in the storage means, the truncation means being adapted to truncate the new message to be recorded, if it is hierarchically coded, as a function of the filled proportion of the storage means;
the truncation means are adapted to be activated at the time of recording a new message;
the truncation means are adapted to be activated if the remaining capacity of the storage means falls below a predetermined threshold; and
the truncation means are associated with means for determining hierarchy levels at which to store messages and are adapted to truncate these messages at the hierarchy levels that have been determined.

The invention further consists in a telephone incorporating a messaging system as described above.

The invention can be better understood in the light of the following description, which is given by way of example only and with reference to the appended drawings, in which:

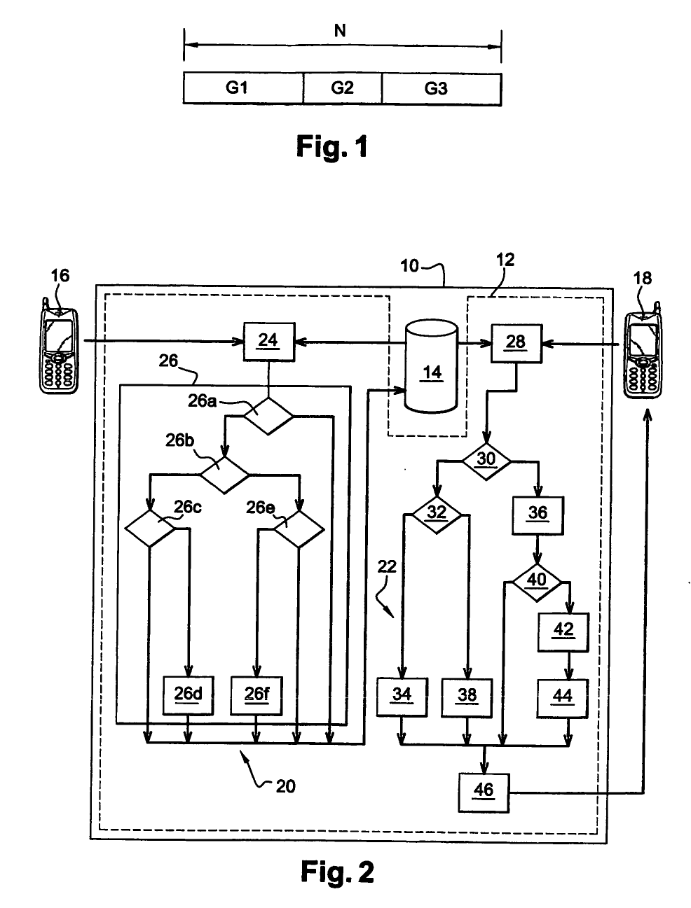

FIG. 1 is a diagram showing the composition of the bit stream of a hierarchically coded message; and

FIG. 2 is a diagram of a messaging system of the invention.

In hierarchical coding systems, also known as scaleable coding systems, binary data resulting from the coding operation is divided into successive layers. A base layer, also called the kernel, is formed of the bits absolutely necessary for decoding the bit stream, determining a minimum decoding quality.

The subsequent layers progressively improve the quality of the signal resulting from the decoding operation, each new layer providing new information which is processed by the decoder to supply at the output a signal of increasing quality.

One advantageous feature of hierarchical codecs is that they enable intervention at any level of the transmission or storage system to eliminate a portion of the bit stream without having to supply any particular indication to the coder or the decoder. The decoder uses the binary information that it receives and produces a signal of corresponding quality.

In practice, hierarchical coding of audio or video signals or data generates, from a portion of the source signal (for example a 20 milliseconds (ms) frame of a speech signal in the case of certain audio coders), a bit stream represented by N bits separated into P successive groups of bits (corresponding to the P layers) G1 to GP, as shown in FIG. 1 for P=3.

The first group G1 constitutes the kernel. The subsequent groups G2 to GP are the layers that enable consecutive quality improvements.

The bit stream from this kind of coder can therefore easily be truncated and the bit rate generated by the same coder can therefore be changed with guaranteed low processing complexity.

Accordingly, in FIG. 1, the group G1 alone, the groups G1 and G2 or the three groups G1, G2 and G3 may be transmitted. The respective expressions level 1, level 2 and level 3 hierarchy apply to these options. The bit rate DH1 offered by hierarchy level 1 is denoted D1, the bit rate DH2 offered by the combined groups G1 and G2 is denoted D1+D2, and the bit rate DH3 offered by all the groups G1 to G3 is denoted D1+D2+D3. Generally speaking, the bit rate DHQ offered by a hierarchy level Q is the sum of the bit rates of all the hierarchy levels at or below the level Q, that is to say:

$$DHQ = {\sum }_{p = 1}^{Q} Dp$$

Consider the example of a hierarchical speech coder operating on 20 ms frames offering a hierarchy on three levels: D1=8 kilobits per second (kbps) for the first group G1, D2=6 kbps for the second group G2, and D3=16 kbps for the third group G3. There is therefore an overall bit rate of 30 kbps, that is to say, for a frame, a bit stream of 75 bytes that can be divided into three consecutive groups G1, G2 and G3 of 20, 15 and 40 bytes, respectively.

For each type of hierarchically coded message, the messaging system can decide to send and/or to store only a portion of the bit stream. The manipulation of the data is relatively simple as there is no algorithmic processing to be effected on the data, merely a hierarchical selection of data.

FIG. 2 shows a messaging system of the invention.

The messaging system 10 represented in FIG. 2 includes a processor unit 12 associated with storage means 14 connected in read mode and in write mode to the processor unit 12.

In different embodiments, the messaging system may be implemented in a communications terminal, for example a telephone incorporating the telephone answering machine function, or in a server independent of any communications terminal and accessible via a transmission network, for example the switched telephone network, the Internet network or any other type of information transmission network.

Accordingly, as shown in FIG. 2, the messaging system 10 is accessible in write mode to a first communications terminal 16 belonging to a user wishing to leave a message for a user of a second communications terminal 18. The terminals 16 and 18 may be telephones, videophones or any other type of communications terminal adapted to send and receive audio and/or video messages and/or data. The generic term “communications terminal” is used in the remainder of the description.

In the conventional way, the user of the communications terminal 16 either calls the communications terminal 18 and is redirected to the messaging system 10 if the user of the communications terminal 18 is not available or enters directly a predetermined number for the messaging system 10. The user of the communications terminal 16 then sends a message, which is received by the messaging system and then stored in the storage means 14.

The messaging system 10 is accessible in read mode from the communications terminal 18, the second user having previously deposited a welcome message in the messaging system in order for the system to be able to recover messages sent to the second user while absent. The user of the communications terminal 18 can access the messaging system 10 in read mode, where applicable using an identifier and an access password, to read messages that were recorded for that user's attention and stored in the storage means 14.

The processor unit 12 of the messaging system 10 includes means 20 for recording and managing the storage of messages sent by the user of the communications terminal 16. Furthermore, the messaging system 10 includes means 22 controlled by the user of the communications terminal 18 for extracting and sending messages.

The recording and storage management means 20 include an analyzer module 24 and a processor module 26.

The function of the analyzer module 24 is to analyze messages to be recorded coming from terminals such as the communications terminal 16 and messages already stored in the storage means 14. This analysis determines certain characteristics inherent to a stored message or a message to be recorded. Those characteristics comprise:
its total size in bytes; and
the maximum number of hierarchy levels.

If coding and/or transmission is effected at the block level, for example at the level of 20 ms frames, it is possible for the number of hierarchy levels per block to vary. In this case, the analyzer module 24 also determines the number of blocks and the number of hierarchy levels for each block. It will be noted that a number of hierarchy levels equal to 1 corresponds either to non-hierarchical coding or to a hierarchical coding kernel. Other characteristics may be determined, such as the maximum bit rate and the bit rate of each block. Remember also that even the bit rate generated by a non-hierarchical coder may vary, and this variation of the bit rate can be monitored by the source, for example when using a DTX type discontinuous transmission mechanism, or by the transmission network, for example in the case of 3GPP AMR multiple bit rate mobile coding.

The result of the above analyses is sent to the processor module 26. The processor module 26 can be activated at regular intervals, at the time of recording a new message, and/or if the remaining capacity of the storage means 14 falls below a predetermined threshold. In all these cases, the processor module 26 tests whether the remaining storage capacity is sufficient or not by comparing it either to a predetermined threshold or to the size of a message to be recorded. It includes a test module 26a for this purpose.

The remaining storage capacity of the storage means 14 is obviously obtained by subtracting the sum of the sizes of the messages already stored in the storage means 14 from the maximum storage capacity of the storage means 14. The predetermined threshold may be defined as a percentage of the maximum storage capacity. It is clear that the analysis of the size of the messages and of the remaining capacity of the storage means will be different depending on whether the distribution of resources in the storage means is global or differentiated. Nevertheless, for conciseness, and given that this kind of analysis is known in the art, these two cases will not be described in more detail. Accordingly, the maximum storage capacity of the means 14 may correspond either to the overall size or to the maximum size allocated to the terminal 18 (or to the user group to which it belongs). Similarly, the size of the messages already stored may be either global (a sum for all the stored messages) or differentiated (a sum for all the stored messages for the terminal 18).

If the remaining storage capacity is sufficient, no processing is applied to the messages already stored. If the analyzer module 24 is activated on recording a new message, the processor means 26 store the message to be recorded in the storage means 14 with no other processing of that message.

If the remaining storage capacity of the storage means 14 is insufficient, the processor means can truncate at least some of the messages already stored in the storage means 14, if they have been coded hierarchically, to increase the remaining storage capacity.

Otherwise, on recording a new message, if the remaining storage capacity is less than the size of the message, the processor means can truncate the message, if it has been coded hierarchically, so that after truncation the size of the message to be stored is less than the remaining storage capacity of the storage means 14.

The processor means 26 may combine the two solutions described above, i.e. truncate the message to be stored and truncate messages already stored in the storage means 14.

Truncation may be effected on the basis of a rule judiciously chosen to truncate messages already stored equitably. For example, the oldest hierarchically coded messages and/or those coded at a higher bit rate or those having a large number of hierarchy levels are truncated first. Clearly the characteristics of the truncation means (for example the number of hierarchy levels to be truncated) may be adapted according to the remaining capacity: if the capacity is very low, there is greater truncation. Conversely, if the remaining capacity is just below the predetermined threshold, then truncation is more limited in terms of the levels to be truncated and/or the number of messages to be truncated.

The processor means 26 therefore include a test module 26b at the output of the test module 26a. If the remaining storage capacity is insufficient, this test module 26b determines if a message to be processed is hierarchically coded.

If not, the message is forwarded to a test module 26c the function whereof is to test if the message to be processed must be transcoded into a format reducing its size. If so, the message to be processed is forwarded to a transcoder module 26d and then sent to the storage means 14. If not, the message is sent directly to the storage means 14.

If the message to be processed is hierarchically coded, the message is forwarded to a test module 26e the function whereof is to test if the message to be processed must be truncated and if so to determine at which hierarchy level it must be truncated.

If the message to be processed does not have to be truncated, it is sent directly to the storage means 14.

Otherwise, it is transmitted to a truncation module 26f the function whereof is to truncate the message to be processed at the hierarchy level that has been determined.

The processing is preferably applied to messages that have been hierarchically coded, which are then truncated, before processing messages that have not been hierarchically coded (the steps 26c and 26d may even be optional).

The processor means 26 including the truncation module 26f skillfully manage the memory space allocated for storing messages.

The extraction and sending means 22 comprise means for analyzing requests formulated by the user of the communications terminal 18. In the conventional way, requests are entered by means of DTMF signals, for example, to command the reading of one or more messages stored in the storage means 14 that the user of the communications terminal 16 is authorized to access.

Information concerning the capacities of the communications terminal 18 to receive messages of a certain size (or bit rate) and/or in a certain coding format is sent to the analysis means 28 with a request.

For example, the communications terminal 18 is a telephone connected to the switched telephone network, a mobile telephone with an onboard coder of the ETSI GSM EFR or 3GPP NB-AMR type or an IP telephone with an onboard coder of the UIT-T G.723-1 or UIT-T G.729 type having minimal message reception capacities. The communications terminal 18 may equally be a telephone equipped with hierarchical decoding means capable of receiving messages coded by hierarchical coders at a given hierarchy level.

In the remainder of the description, it is considered that a hierarchically coded message is coded using a hierarchical coder at least one layer whereof can be decoded by at least one decoder other than a hierarchical decoder. Likewise, it is considered that a hierarchical decoder can decode a message coded by a coder other than a hierarchical coder corresponding to the hierarchical decoder. That coder may itself be hierarchical or not. A message stored in the means 14 is considered compatible with the reader terminal 18 if at least a portion of the bit stream of that message can be decoded by the terminal 18.

Various situations may arise upon extracting the message at the command of the user of the communications terminal 18:
the message to be sent is not coded hierarchically and the terminal 18 is not adapted to receive the message;
the message to be sent is not coded hierarchically and the terminal 18 is adapted to receive the message;
the message to be sent is coded hierarchically and the terminal 18 is not adapted to receive the message; and
the message to be sent is coded hierarchically and the terminal 18 is adapted to receive at least a portion of the bit stream of the message.

In the last of the above four situations, it is necessary to distinguish between, on the one hand, the situation where the capacities in terms of bit rate for access to the terminal 18 are at least equal to the bit rate of the message and, on the other hand, the contrary situation.

The extraction and sending means 22 are therefore configured to process these situations in a specific manner.

To this end, they comprise a first test module 30. This test module 30 determines if the message to be sent extracted from the storage means 14 by the analyzer module 28 is hierarchically coded.

If not, i.e. if the message to be sent is coded in a non-hierarchical manner, it is then forwarded to a second test module 32 the function whereof is to test the compatibility of the format of the message to be sent with the format acceptable by the reader terminal 18.

If the format of the message to be sent is compatible with a format acceptable by the reader terminal 18, then the test module 32 forwards the message to be sent directly to a sender module 46 the function whereof is to manage packetization and to send the message to the reader terminal 18 via a transmission network.

If the format of the message to be sent is not compatible with a format acceptable by the reader terminal 18, the test module 32 forwards the message to be sent to a transcoding module 34, to make it compatible. The transcoded message is then forwarded to the sender module 46.

If the message to be sent is stored in the storage means 14 in the form of a hierarchically coded message, then the test module 30 forwards that hierarchically coded message to a second test module 36 similar to the test module 32. In other words, the test module 36 tests the aptitude of the reader terminal 18 to receive at least a portion of the bit stream of the hierarchically coded message.

If the format of the message to be sent is not compatible with a format acceptable by the reader terminal 18, the message to be sent is forwarded by the test module 36 to a transcoder module 38 similar to the transcoder module 34, to transcode the message to be sent. The transcoded message is then forwarded to the sender module 46.

If the format of the message to be sent is compatible with a format acceptable by the reader terminal 18 (i.e. if the reader terminal 18 is adapted to receive at least one layer of hierarchically coded messages), the message to be sent is forwarded by the module 36 to a test module 40 the function whereof is to test the compatibility in terms of bit rate of the format of the message to be sent with the capacity in terms of bit rate acceptable by the reader terminal 18.

If the reader terminal 18 has capacities sufficient to receive the whole of the message to be sent, then the test module 40 forwards the message directly to the sender module 46.

If not, the test module 40 forwards the hierarchically coded message to a truncation module 44. That truncation module truncates the hierarchically coded message as a function of the capacities of the reader terminal 18. The truncated message is then forwarded to the sender module 46.

It will be noted that the invention is not limited to the embodiment described above.

In particular, the capacity in terms of access to the reader terminal 18 and the size per block of the message to be sent may vary during sending. In this case, the method described above must obviously be adapted to be iterated over the blocks to be sent from the bit rate compatibility test step 40.

If the user of the reader terminal 18 wishes to listen to a plurality of messages stored by the messaging system, it is possible, without adding further complexity, to concatenate the messages before sending them.

It is clear that a messaging system according to the invention can store digital messages from terminals with heterogeneous capacities and send digital messages to reader terminals with reading capacities that are also heterogeneous. It is also apparent that a messaging system according to the invention improves storage means capacity management by optimizing the trade-off between quality and the number of messages stored.

This is made possible by means for determining hierarchy levels and for effecting truncation at the hierarchy levels that have been determined. These means are implemented in the recording and storage management means of the messaging system and in the extraction and sending means of the same system, these means being simple to implement if the messages are coded hierarchically.

The invention is particularly beneficial when a message is coded by a hierarchical coder the kernel whereof is compatible with a standardized coder, i.e. when the kernel of the hierarchically coded message conforms to a predetermined standard, for example the G.723.1 standard or the G.729 standard. In fact, by exploiting the hierarchy and the compatibility of the kernel with a standard widely used in terminals and/or other components of communications systems, such as gateways, the system advantageously enables the processing of messages coming from or going to a large number of terminals (terminals supporting a hierarchical coder with standardized kernel and terminals supporting only the standardized coder).

1. A messaging system (10) including storage means (14) for storing digital audio and/or video messages and/or data, characterized in that it includes truncation means (26f, 44) for truncating messages coded by hierarchical coders for recording messages in the storage means and/or for forwarding messages already recorded in the storage means.

2. A messaging system (10) according to claim 1, including sending means (22) for forwarding to a remote reader terminal (18) a message already recorded in the storage means coded by a hierarchical coder and means for determining a hierarchy level at which the message to be sent must be forwarded to the remote reader terminal (18) so that the message is truncated by the truncation means (44) at the hierarchy level that has been determined.

3. A messaging system (10) according to claim 2, wherein the means for determining the hierarchy level of the message to be sent are operative as a function of parameters relating to the status of the remote terminal and/or the status of the transmission network.

4. A messaging system (10) according to claim 2, wherein, the remote terminal being adapted to read only messages to a predetermined format that is not compatible with the format of the message to be sent, the system further includes processor means (34, 38) for processing the message to be sent to render it compatible with that predetermined format.

5. A messaging system (10) according to claim 1, wherein the truncation means (26 f) are adapted to truncate messages coded by hierarchical coders and already stored as a function of the filled proportion of the storage means (14).

6. A messaging system (10) according to claim 1, including recording means (20) for recording a new digital message in the storage means (14), the truncation means (26f) being adapted to truncate the new message to be recorded, if it is hierarchically coded, as a function of the filled proportion of the storage means (14).

7. A messaging system (10) according to claim 5, wherein the truncation means (26f) are adapted to be activated at the time of recording a new message.

8. A messaging system (10) according to claim 5, wherein the truncation means (26f) are adapted to be activated if the remaining capacity of the storage means (14) falls below a predetermined threshold.

9. A messaging system (10) according to claim 5, wherein the truncation means (26f) are associated with means (26e) for determining hierarchy levels at which to store messages and are adapted to truncate these messages at the hierarchy levels that have been determined.

10. A telephone including a messaging system (10) according to claim 1.
